(19) United States
(12) Patent Application Publication
(10) Pub. No.: US 2011/0194658 A1
(43) Pub. Date: Aug. 11, 2011

(54) DIGITAL FRONT-END STRUCTURE OF SUB-SAMPLING BASED DIGITAL RECEIVER

(75) Inventor: Seon-Ho HAN, Daejeon (KR)

(73) Assignee: Electronics and Telecommunications Research Institute, Daejeon (KR)

(21) Appl. No.: 13/024,688

(22) Filed: Feb. 10, 2011

(30) Foreign Application Priority Data
Feb. 11, 2010 (KR) 10-2010-0012825
Oct. 8, 2010 (KR) 10-2010-0098105

(51) Int. Cl. H04B 1/10

(52) U.S. Cl. 375/350

(57) ABSTRACT

Provided is a digital receiver for use in a wireless communication transmitting/receiving system. The digital receiver oversamples a desired-band signal during performing a subsampling operation for converting an RF signal into an IF signal or DC signal so that an unwanted signal is also converted into a digital signal, and then, eliminated in a digital block.

### CROSS-REFERENCE TO RELATED APPLICATIONS

This U.S. non-provisional patent application claims priority under 35 U.S.C. §119 of Korean Patent Application Nos. 10-2010-0012825, filed on Feb. 11, 2010, and 10-2010-0098105, filed on Oct. 8, 2010, the entire contents of which are hereby incorporated by reference.

### BACKGROUND OF THE INVENTION

The present invention disclosed herein relates to a digital front-end structure of a subsampling-based digital receiver.

It has many shortcomings to use a typical analog design method for developing a wireless transmitter-receiver suitable for a multiband signal and a multi-application field in aspect of power consumption, chip size, and adapting to market.

A low-noise amplifier, a mixer, a channel selection filter, a variable amplifier, and the like of a typical wireless receiver have been designed in an analog method. The designing method for some of the structural blocks has been changed to a digital method; however, most of them are still designed in the analog method.

FIG. 1 is a block diagram illustrating a receiver designed in a typical analog method. FIG. 1 illustrates an example of a receiver having a direct conversion structure among various analog receivers. As shown, in the receiver of FIG. 1, a signal received by an antenna is passed through a band pass filter 2, amplified by a low-noise amplifier 4, and then, applied to down-conversion mixers 6 and 8. For effectively obtaining only desired-channel signal among received signals, the down-conversion mixers 6 and 8 lowers a carrier frequency of the signals, and then, applies the down-converted signals to corresponding low-pass filters 14 and 15. The low-pass filters 14 and 15 eliminate unwanted signals among the down-converted signals.

The reason why the unwanted signals are eliminated by applying the signals whose carrier frequency has been lowered to the low-pass filters 14 and 15 is that actual implementation of a filter is easier when an operating frequency is low. Due to the filtering operation of the low-pass filters 14 and 15, the received signal referred to as 10a as directed through the arrow reference number AR1 is filtered to obtain a desired signal referred to as 20a as directed through the arrow reference number AR2.

The signals outputted from the low-pass filters 14 and 15 are applied to Variable Gain Amplifiers (VGAs) 16 and 17 to adjust gains, and then, applied to corresponding Analog to Digital Converters (ADCs) 18 and 19. Since the VGAs 16 and 17 make a reference magnitude of the signals applied to the ADCs 18 and 19 constant, dynamic ranges of input signals of the ADCs 18 and 19 may be designed to be small. Also, since the frequencies of the input signals of the ADCs 18 and 19 have been lowered by the down-conversion mixers 6 and 8, operating frequencies of the ADCs 18 and 19 are decreased accordingly. Therefore, the ADCs 18 and 19 may be simply designed.

Also, a Phase Locked Loop (PLL) 12 is also one of factors for simply designing the structural blocks of the receiver of FIG. 1. That is, since a frequency synthesizer using the PLL 12 may change a Local Oscillation (LO) frequency according to a channel frequency, a channel center frequency corresponding to a respective signal channel may be generated. Therefore, the low-pass filters following the low-conversion mixers have the same filtering characteristics even though channel center frequencies of the signals received through the antenna are different from each other. As a result, all the low-pass filters having the same filtering characteristics may be used.

Meanwhile, even a typical digital receiver has a merit of overcoming the problems of the analog receiver, e.g., power consumption, chip size, and fast market adaptability; however, it has many difficulties to actually implement the digital receiver. For instance, sub-sampling method, noise elimination, integration, and implementation of analog-digital converter for the typical digital receiver still needed to be improved.

### SUMMARY OF THE INVENTION

The present invention provides a wireless communication receiver suitable for a digital design.

The present invention also provides a wireless communication digital receiver capable of simply designing an analog block and optimizing a digital block.

The present invention also provides a digital receiver adopting a subsamping method which has a good performance for eliminating noise.

The present invention also provides a digital receiver capable of digitally eliminating noise signals adjacent to a desired signal.

The present invention also provides a digital receiver mainly designed in a digital method and more compactly designed.

Embodiments of the present invention provide receivers including an RF/analog block including a noise reduction and signal magnitude mapping variable amplification unit and an analog-to-digital conversion unit, wherein the noise reduction and signal magnitude mapping variable amplification unit includes a filter and an amplifier and is configured to amplify and band-pass an analog signal, reduce a white noise and an interfering signal except for a band signal, and convert a relatively wide amplitude range of an input signal into an input signal range of a next stage, and the analog-to-digital conversion unit is configured to convert the analog signal passed through the noise reduction and signal magnitude mapping variable amplification unit into a digital signal of a DC-frequency band or intermediate-frequency band by performing a sampling operation using a sampling clock of a preset frequency for a carrier frequency of a desired signal to be sub-sampled and for a band of the desired signal to be over-sampled, have a range of input signal magnitude capable of processing all of the desired signal and its neighboring unwanted signal, and generate the digital signal for each I/Q path being provided with a high-speed input unit for sampling a signal of higher frequency than the sampling clock frequency; and a digital signal restoration block including a digital low-pass filter, a digital variable gain amplifier, an auto gain control unit, a clock frequency generator, and a digital processor, wherein the digital low-pass filter is configured to select a signal of a desired channel among output signals of the analog-to-digital conversion unit, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

In some embodiments, the clock frequency generator may have programmability to an output frequency for selecting a desired-channel signal and keep a center frequency of an output band of the analog-to-digital conversion unit constant by varying a sampling frequency supplied to the analog-to-digital conversion unit.

In other embodiments, the digital low-pass filter may have a structure capable of varying a bandwidth for selecting a desired-channel signal.

In still other embodiments, the digital low-pass filter may have a form of an I/Q path filter or an I/Q complex filter.

In even other embodiments, the digital low-pass filter, the digital variable gain amplifier, and the auto gain control unit may be arbitrarily arranged.

In other embodiments of the present invention, receivers include an RF/analog block including a noise reduction and signal magnitude mapping variable amplification unit and an analog-to-digital conversion unit, wherein the noise reduction and signal magnitude mapping variable amplification unit includes a filter and an amplifier and is configured to amplify and band-pass an analog signal, reduce a white noise and an interfering signal except for a band signal, and convert a relatively wide amplitude range of an input signal into an input signal range of a next stage, and the analog-to-digital conversion unit is configured to convert the analog signal passed through the noise reduction and signal magnitude mapping variable amplification unit into a digital signal of a DC-frequency band or intermediate-frequency band by performing a sampling operation using a sampling clock of a preset frequency for a carrier frequency of a desired signal to be sub-sampled and for a band of the desired signal to be over-sampled, have a range of input signal magnitude capable of processing all of the desired signal and its neighboring unwanted signal, and generate the digital signal for each I/Q path being provided with a high-speed input unit for sampling a signal of higher frequency than the sampling clock frequency; and a digital signal restoration block including a digital down mixer, a digital low-pass filter, a digital variable gain amplifier, an auto gain control unit, a clock frequency generator, and a digital processor, wherein the digital down mixer is configured to receive an output signal of the analog-to-digital conversion unit and down-convert its center frequency into a DC band, the digital low-pass filter is configured to select a signal of a desired channel among output digital signals of the digital down mixer, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

In some embodiments, the clock frequency generator may have programmability to an output frequency for selecting a desired-channel signal, keep a center frequency of an output band of the digital down mixer constant by varying a frequency of a mixing signal supplied to the digital down mixer, and vary a sampling clock frequency supplied to the analog-digital conversion unit.

In other embodiments, the digital low-pass filter may have a structure capable of varying a bandwidth for selecting a desired-channel signal.

In still other embodiments, the digital low-pass filter may have a form of an I/Q path filter or an I/Q complex filter.

In even other embodiments, the digital down mixer may have a form of an I/Q path mixer or an I/Q complex mixer.

In yet other embodiments, the digital down mixer, the digital low-pass filter, the digital variable gain amplifier, and the auto gain control unit may be arbitrarily arranged.

In further embodiments, the analog-to-digital conversion unit in the RF/analog block may be structured with I/Q ADCs and the ADCs may directly receive orthogonal I/Q clocks respectively.

In still other embodiments of the present invention, receivers include an RF/analog block including a noise reduction and signal magnitude mapping variable gain amplification unit and an analog-to-digital conversion unit, wherein the noise reduction and signal magnitude mapping variable amplification unit includes a filter and an amplifier and is configured to amplify and band-pass an analog signal, reduce a white noise and an interfering signal except for a band signal, and convert a relatively wide amplitude range of an input signal into an input signal range of a next stage, and the analog-to-digital conversion unit is configured to convert the analog signal passed through the noise reduction and signal magnitude mapping variable amplification unit into a digital signal of a DC-frequency band or intermediate-frequency band by performing a sampling operation using a sampling clock of a preset frequency for a carrier frequency of a desired signal to be sub-sampled and for a band of the desired signal to be over-sampled, have a range of input signal magnitude capable of processing all of the desired signal and its neighboring unwanted signal, and generate the digital signal as a single path being provided with a high-speed input unit for sampling a signal of higher frequency than the sampling clock frequency; and a digital signal restoration block including a quadrature digital down mixer, a digital low-pass filter, a digital variable gain amplifier, an auto gain control unit, a clock frequency generator, and a digital processor, wherein the quadrature digital down mixer is configured to receive an output signal of the analog-to-digital conversion unit and down-convert its center frequency into a DC band, the digital low-pass filter is configured to select a signal of a desired channel among output digital signals of the digital down mixer, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

In some embodiments, the clock frequency generator may have programmability to an output frequency for selecting a desired-channel signal, keep a center frequency of an output band of the quadrature digital down mixer constant by varying a frequency of a mixing signal supplied to the quadrature digital down mixer, and vary a sampling clock frequency supplied to the analog-digital conversion unit.

In other embodiments, the digital low-pass filter may have a structure capable of varying a bandwidth for selecting a desired-channel signal.

In still other embodiments, the digital low-pass filter may have a form of an I/Q path filter or an I/Q complex filter.

In even other embodiments, the quadrature digital down mixer may have a form of an I/Q path mixer or an I/Q complex mixer.

In yet other embodiments, the quadreature digital down mixer, the digital low-pass filter, the digital variable gain amplifier, and the auto gain control unit may be arbitrarily arranged.

In further embodiments, the filter between the amplifier and the analog-to-digital conversion unit may have a function of impedance conversion for changing a voltage amplitude of a signal power transferred to an ADC and a function of frequency selective noise cancelling using a frequency selective 180°-phase converter and a common mode suppression circuit.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a typical analog receiver;

FIG. 2 is a block diagram illustrating a receiver of quadrature DC-conversion type according to an embodiment of the present invention;

FIG. 3 is a block diagram illustrating a receiver of quadrature intermediate frequency conversion type according to another embodiment of the present invention;

FIG. 4 is a block diagram illustrating a receiver of intermediate frequency conversion type according to still another embodiment of the present invention;

FIG. 5 is a block diagram illustrating a subsampling-based RF/analog block according to the present invention;

FIG. 6 is a block diagram illustrating a subsampling structure using I/Q ADC according to an application of the present invention; and

FIG. 7 is a block diagram illustrating a subsampling structure using single ADC according to another application of the present invention.

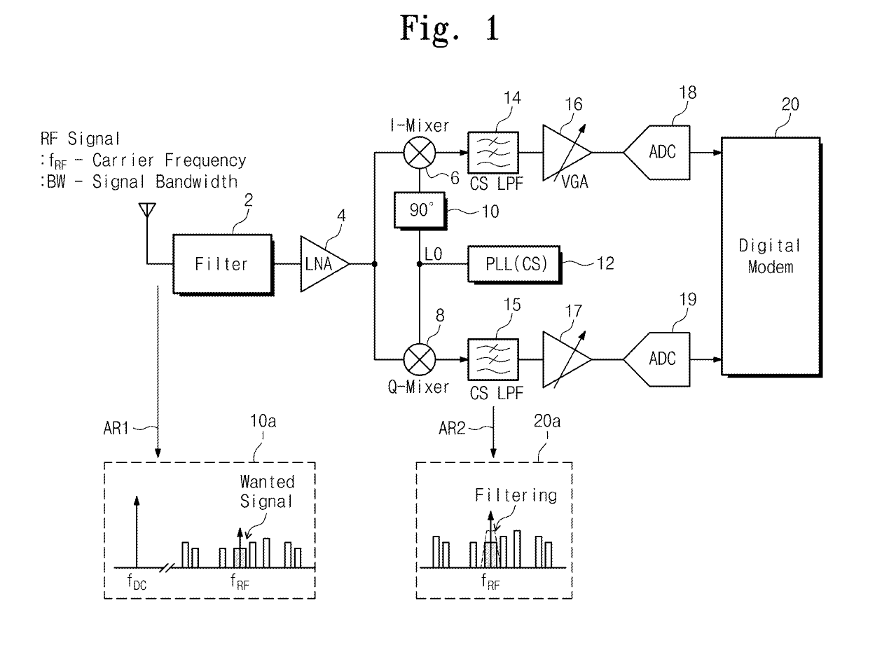

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, when it is commented that some devices or lines are connected to a target block, the connection includes not only a direct connection but also an indirect connection through another device.

Also, like reference numerals refer to like elements throughout. In some drawings, connections between devices and lines are illustrated just for efficiently explaining technical contents, and thus, other devices or blocks may be further included.

The embodiments exemplified and described in this disclosure may include their complementary embodiments. It should be noted that typical communication processes between a mobile communication system and a mobile communication terminal are omitted so as not to obscure the present invention.

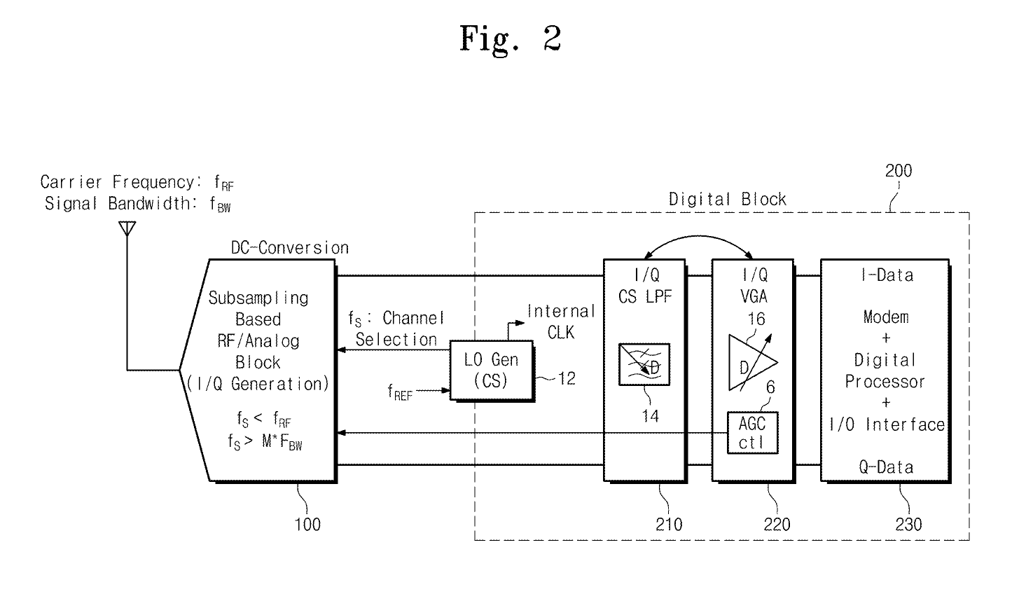

FIG. 2 is a block diagram illustrating a receiver of quadrature DC-conversion type according to an embodiment of the present invention. The digital receiver of FIG. 2 also has a structure for direct conversion.

Referring to FIG. 2, the digital receiver includes an RF/analog block 100 and a digital signal restoration block 200.

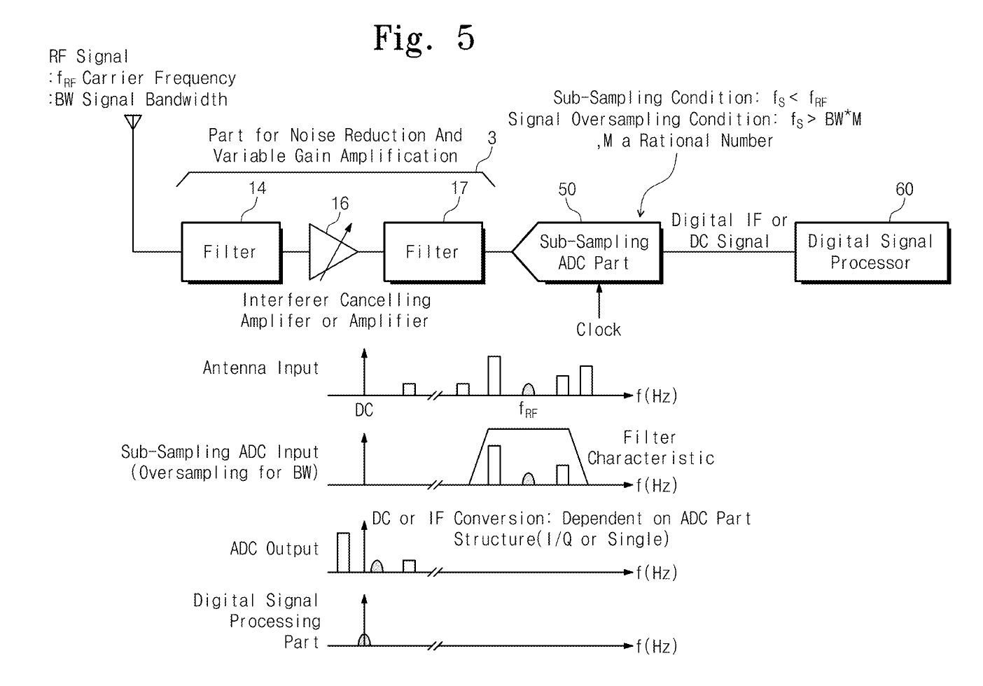

The RF/analog block 100 includes a noise reduction and signal magnitude mapping variable amplification unit 3 and an analog-to-digital conversion (ADC) unit 50 as illustrated in FIG. 5. The noise reduction and signal magnitude mapping variable amplification unit 3 includes a filter and an amplifier to amplify and band-pass an analog signal. The noise reduction and signal magnitude mapping variable amplification unit 3 reduces a white noise and an interfering signal except for a band signal and converts a relatively wide range of an input signal into an input signal range of a next stage. The analog-to-digital conversion unit 50 converts the analog signal passed through the noise reduction and signal magnitude mapping variable amplification unit 3 into a digital signal of a DC-frequency band or intermediate-frequency band by performing a sampling operation using a sampling clock of a preset frequency for a carrier frequency of a desired signal to be sub-sampled and for a band of the desired signal to be over-sampled. The analog-to-digital conversion unit 50 is provided with a high-speed input unit for sampling a signal of higher frequency than the sampling clock frequency and has a range of input signal magnitude capable of processing all of the desired signal and its neighboring unwanted signal. The analog-to-digital conversion unit 50 generates the digital signal for each I/Q path.

The digital signal restoration block 200 includes a digital low-pass filter 210, a digital variable gain amplifier 16, an auto gain control unit 6, a clock frequency generator 12, and a Digital Signal Processor (DSP) 230. The digital low-pass filter 210 selects a signal of a desired channel among output signals of the analog-to-digital conversion unit 50. The digital variable gain amplifier 16 serves to make a digital-filtered signal have a referential arbitrary signal magnitude. The auto gain control unit 6 detects a magnitude of a signal to automatically vary a gain of the digital variable gain amplifier 16 according to the signal magnitude. The clock frequency generator 12 generates the sampling clock of the analog-to-digital conversion unit 50. The digital signal processor 230 processes a signal passed through the digital variable gain amplifier 16.

Herein, the auto gain control unit 6 detects the signal magnitude, i.e., signal power, in a feedforward or feedback method. The methods may be selected according to an implementing method for the auto gain control unit 6. The clock frequency generator 12 receives an external reference frequency signal f_{REF} and generates the sampling clock of the ADC. The clock frequency generator 12 has programmability for an output frequency and keeps a center frequency of an output band of the analog-to-digital conversion unit 50 constant by varying the sampling frequency supplied to the analog-to-digital conversion unit 50.

Also, for selecting a signal of a desired channel, the digital low-pass filter 210 has a structure for varying a bandwidth. For eliminating an image signal, it may have a form of I/Q path filter or I/Q complex filter.

In FIG. 2, the digital low-pass filter 210, the digital variable gain amplifier 16, and the auto gain control unit 6 in the digital signal restoration block 200 may be arranged for efficient hardware structure.

The receiver of FIG. 2 having the structure for direct conversion may vary the sampling clock of the ADC so that a channel filter following the ADC may be simply designed. Therefore, after passing the ADC, the center frequency of down-converted signal becomes constant.

According to the structure of the receiver of FIG. 2, the digital low-pass filter 210 as a channel filter 14 may support signals of various channel bandwidths if the digital low-pass filter 210 has just programmability for a desired bandwidth.

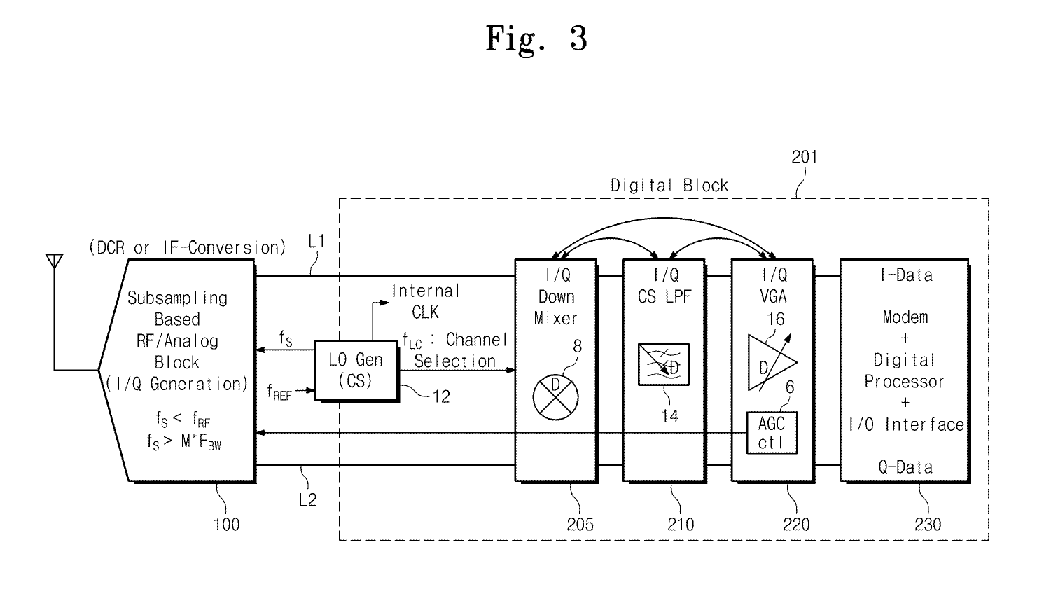

FIG. 3 is a block diagram illustrating a receiver of quadrature Intermediate Frequency (IF) conversion type according to another embodiment of the present invention. The receiver of FIG. 3 having a structure for IF conversion additionally includes a digital down mixer 8 in comparison with the receiver of FIG. 2. The digital down mixer 8 serves to receive an output signal of the ADC and down-convert its center frequency into a DC band.

Referring to FIG. 3, the digital receiver includes an RF/analog block 100 and a digital signal restoration block 201.

The RF/analog block 100 includes a noise reduction and signal magnitude mapping variable amplification unit 3 and an analog-to-digital conversion unit 50 as illustrated in FIG. 5. The noise reduction and signal magnitude mapping variable gain amplification unit 3 includes a filter 14 and an amplifier 16 to amplify and band-pass an analog signal. The noise reduction and signal magnitude mapping variable gain amplification unit 3 reduces a white noise and an interfering signal except for a band signal and converts a relatively wide range of an input signal into an input signal range of a next stage. The analog-to-digital conversion unit 50 converts the analog signal passed through the noise reduction and signal magnitude mapping variable gain amplification unit 3 into a digital signal of a DC-frequency band or intermediate-frequency band by performing a sampling operation using a sampling clock of a preset frequency for a carrier frequency of a desired signal to be sub-sampled and for a bandwidth of the desired signal to be over-sampled. The analog-to-digital conversion unit 50 is provided with a high-speed input unit for sampling a signal of higher frequency than the sampling clock frequency and has a range of input signal magnitude capable of processing all of the desired signal and its neighboring unwanted signal. The analog-to-digital conversion unit 50 generates the digital signal for each I/Q path.

The digital signal restoration block 201 includes a digital down mixer 205, a digital low-pass filter 210, a digital variable gain amplifier 16, an auto gain control unit 6, a clock frequency generator 12, and a digital signal processor 230. The digital down mixer 205 receives an output signal of the analog-to-digital conversion unit 50 and converts its center frequency into the DC band. The digital low-pass filter 210 selects a signal of a desired channel among output digital signals of the digital down mixer 205. The digital variable gain amplifier 16 serves to make a digital-filtered signal have a referential arbitrary signal magnitude. The auto gain control unit 6 detects a magnitude of a signal to automatically vary a gain of the digital variable gain amplifier 16 according to the signal magnitude. The clock frequency generator 12 generates the sampling clock of the analog-to-digital conversion unit 50. The digital signal processor 230 processes a signal passed through the digital variable gain amplifier 16.

The structure of the receiver of FIG. 3 is for DCR or IF conversion. Since the digital mixer is installed in a next stage of the ADC, the channel filter for processing a signal may be simply designed. According to the receiver structure of FIG. 3, in comparison with that of FIG. 2, even though the center frequency of a desired channel is changed, the sampling clock frequency of the ADC may be kept constant and a Local Oscillation (LO) signal supplied to the digital mixer may be varied. Accordingly, even though the digital signal converted by the ADC has various channel center frequencies, the filter following the mixer may be simply designed because the center frequency of the signal down-converted by the mixer is constant.

By structuring the receiver as described above, the channel filter may support signals of various channel bandwidths if the channel filter has just programmability for a desired bandwidth. Similarly, the digital down mixer 205, the digital low-pass filter 210, the digital variable gain amplifier 16, and the auto gain control unit 6 in the digital block may be arranged for efficient hardware structure.

The digital down mixer 205 may be implemented as various forms such as a typical I/Q mixer or complex mixer for eliminating an image signal. The digital low-pass filter 210 also has a structure for varying a bandwidth and may have a form of a typical I/Q path filter or I/Q complex filter for eliminating an image signal.

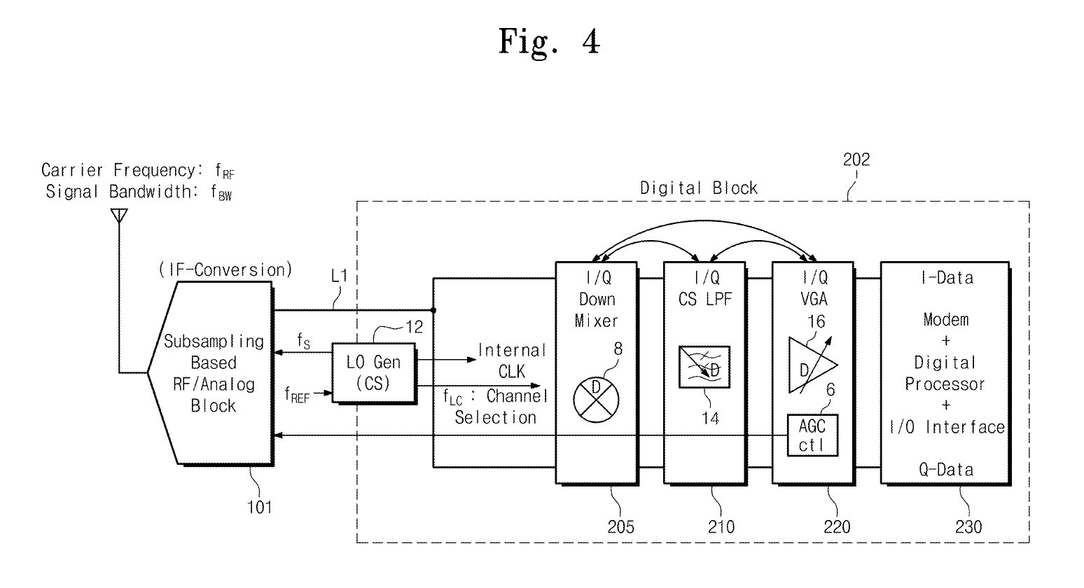

FIG. 4 is a block diagram illustrating a receiver of IF conversion type according to still another embodiment of the present invention. The receiver of FIG. 4 has a structure for IF conversion and a single ADC is included in an RF/analog block.

Referring to FIG. 4, the ADC of an RF/analog block 101 provides a digital signal through a single path.

That is, the RF/analog block 101 includes a noise reduction and signal magnitude mapping variable amplification unit 3 of FIG. 5 and an analog-to-digital conversion unit 50 of FIG. 5. The noise reduction and signal magnitude mapping variable gain amplification unit 3 includes a filter 14 of FIG. 5 and an amplifier 16 of FIG. 5 to amplify and band-pass an analog signal. The noise reduction and signal magnitude mapping variable gain amplification unit 3 reduces a white noise and an interfering signal except for a band signal and converts a relatively wide range of an input signal into an input signal range of a next stage.

In FIG. 4, the analog-to-digital conversion unit 50 converts the analog signal passed through the noise reduction and signal magnitude mapping variable gain amplification unit 3 into a digital signal of a DC-frequency band or intermediate-frequency band by sampling the received analog signal using a sampling clock of a preset frequency for a carrier frequency of a desired signal to be sub-sampled and for a band of the desired signal to be over-sampled. The analog-to-digital conversion unit 50 is provided with a high-speed input unit for sampling a signal of higher frequency than the sampling clock frequency and has a range of input signal magnitude capable of processing all of the desired signal and its neighboring unwanted signal. The analog-to-digital conversion unit 50 generates the digital signal as a single path.

In FIG. 4, the digital signal restoration block 202 includes a quadrature digital down mixer 205, a digital low-pass filter 210, a digital variable gain amplifier 16, an auto gain control unit 6, a clock frequency generator 12, and a digital signal processor 230. The quadrature digital down mixer 205 receives an output signal of the analog-to-digital conversion unit 50 and converts its center frequency into the DC band. The digital low-pass filter 210 selects a signal of a desired channel among output digital signals of the digital down mixer 205. The digital variable gain amplifier 16 serves to make a digital-filtered signal have a referential arbitrary signal magnitude. The auto gain control unit 6 detects a magnitude of a signal to automatically vary a gain of the digital variable gain amplifier 16 according to the signal magnitude. The clock frequency generator 12 generates the sampling clock of the analog-to-digital conversion unit 50. The digital signal processor 230 processes a signal passed through the digital variable gain amplifier 16.

The receiver of FIG. 4 has a structure for the IF conversion. According to the structure of the receiver, a signal is applied to the I/Q digital mixer in the next stage of the ADC, and thus, the channel filter for processing a signal is simply designed.

In comparison with the receiver of FIG. 2, the receiver of FIG. 4 has a structural merit of using just one ADC. Also, even though the center frequency of a desired channel is changed, the sampling clock frequency of the ADC may be kept constant and a LO signal supplied to the digital mixer may be varied. Accordingly, even though the digital signal converted by the ADC has various channel center frequencies, the filter following the mixer may be simply designed because the center frequency of the signal down-converted by the mixer is constant.

By structuring the receiver as described above, the channel filter may support signals of various channel bandwidths if the channel filter has just programmability for a desired bandwidth. Similarly, the digital down mixer 205, the digital low-pass filter 210, the digital variable gain amplifier 16, and the auto gain control unit 6 in the digital block may be arranged for efficient hardware structure.

The digital down mixer 205 may be implemented as various forms such as a typical I/Q mixer or complex mixer for eliminating an image signal. The digital low-pass filter 210 also has a structure for varying a bandwidth and may have a form of a typical I/Q path filter or I/Q complex filter for eliminating an image signal.

FIG. 5 is a block diagram illustrating a subsampling-based RF/analog block according to the present invention.

In FIG. 5, a noise reduction and signal magnitude mapping variable amplification unit 3 and a subsampling-based analog-to-digital conversion unit 50 correspond to the above-described RF/analog block.

The noise reduction and signal magnitude mapping variable amplification unit 3 includes a filter and an amplifier to amplify and band-pass an analog signal. The noise reduction and signal magnitude mapping variable amplification unit 3 reduces a white noise and an interfering signal except for a band signal and converts a relatively wide amplitude range of an input signal into an input signal range of a next stage.

The analog-to-digital conversion unit 50 converts the analog signal passed through the noise reduction and signal magnitude mapping variable amplification unit 3 into a digital signal of a DC-frequency band or intermediate-frequency band by performing a sampling operation using a sampling clock of a preset frequency for a carrier frequency of a desired signal to be sub-sampled and for a band of the desired signal to be over-sampled. The analog-to-digital conversion unit 50 is provided with a high-speed input unit for sampling a signal of higher frequency than the sampling clock frequency and has a range of input signal magnitude capable of processing all of the desired signal and its neighboring unwanted signal. The analog-to-digital conversion unit 50 generates the digital signal for each I/Q path or as a single channel.

The subsampling-based receiver according to the present invention converts an analog signal to a digital signal using minimum analog blocks. Therefore, design difficulty or design time due to the analog design is decreased, and the chip size or power consumption is reduced or minimized. Also, although the subsampling-based receiver receives a high-frequency RF signal, it is possible to use the ADC having a low operating frequency. A processing speed for a converted digital signal is much slower in comparison with a Nyquist sampling method, and thus, there are various merits in an aspect of power consumption and noise elimination characteristics.

Referring to waveforms of FIG. 5, it is shown that a signal received through an antenna, i.e., a first waveform, is processed by the RF/analog block including the ADC so that a digital signal, i.e., a last waveform, in which a noise has been efficiently eliminated, is obtained. In the waveforms, a horizontal axis denotes a frequency and a vertical axis denotes a magnitude (amplitude) of a signal. Since a noise is efficiently eliminated by the filter in front of the ADC and an output of the ADC is obtained as the third waveform, a digital receiver may be efficiently designed.

It is preferable to determine the subsampling frequency considering attenuation of an adopted filter.

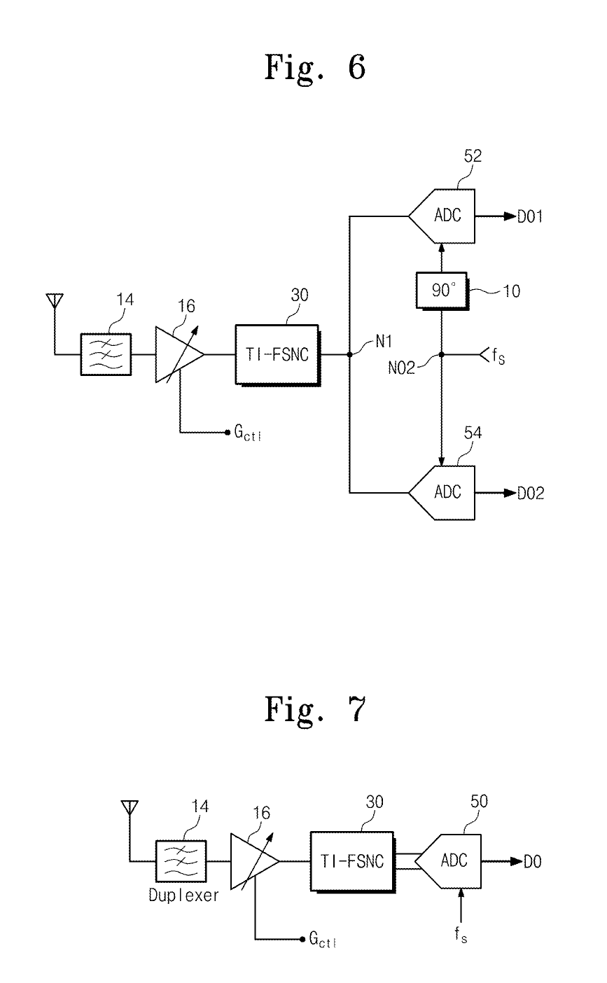

FIGS. 6 and 7 are diagrams illustrating a sampling method and a noise elimination method of the ADC in a subsampling-based structure.

Firstly, referring to FIG. 6, a subsampling-based receiver using an I/Q ADC includes a filter 14, a variable amplifier 16, a Frequency Selective Noise Canceller (FSNC) 30, and first and second ADCs 52 and 54. Meanwhile, referring to FIG. 7, a subsampling-based receiver using a single ADC includes a filter 14, a variable amplifier 16, an FSNC 30, and an ADC 50.

Firstly, in FIG. 6, the first and second ADCs are I/Q ADCs and operate independently receiving orthogonal I/Q sampling clocks. The I/Q ADCs in the RF/analog block directly receive the orthogonal I/Q clocks respectively. In the case of using ADC of I/Q path, since signals separated to I/Q in a mixer are inputted to I/Q ADCs according to a typical I/Q separation method, the signals already separated to I/Q signals are sampled using sampling clocks having the same phase in the I/Q ADCs. On the contrary, in the case of FIG. 6, the I/Q signals previously separated in the front stage are not sampled using sampling clocks of same phase; however, an output signal of a node N1 outputted from the FSNC 30 is directly and respectively sampled using clocks having a phase difference of 90°, i.e., a first clock and a second clock orthogonal to the first clock. Accordingly, among I/Q ADCs, an output of the I-ADC 52 and an output of the Q-ADC 54 become digital signals having a phase difference of 90°. The phase difference of the digital outputs is compensated by a DSP installed in a following stage. As a result, since the compensation by the DSP is performed in a digital signal processing method, the compensating process is correct and simple.

Also, according to a typical receiver, if it is assumed that a clock phase is adjusted to an I-channel when I/Q ADCs perform a sampling operation, data of Q-channel have a relative phase difference in comparison with data of I-channel. Therefore, a data eye is reduced. However, in the case of the receiver of FIG. 6, since signals of I-channel and Q-channel are respectively sampled using the clock having a phase difference of 90°, the shortcoming of reduced data eye is overcome. Further, additional sampler is removed in the receiver of FIG. 6, an area for a chip is decreased and power consumption is reduced. Also, in comparison with a typical receiver adopting a passive sub-sampler, a signal power reduction may be avoided.

As illustrated in FIGS. 6 and 7, the filter installed between the variable gain amplifier 16 and the ADCs 50, 52, and 54 has a function of impedance conversion for changing a voltage level of a signal power transferred to the ADCs and a function of frequency selective noise cancelling using a frequency selective 180°-phase converter and a common mode suppression circuit.

According to the receiver structured with just the amplifier and ADC, since all amplifications should be performed in the front stage of the ADC, a degree of amplification is a big issue. Therefore, the FSNC 30 converts the voltage amplitude of the signal power transferred to the ADC for reducing the burden of amplification of the amplifier in front of the ADC. During converting the signal voltage level, a signal-to-noise ratio required by the ADC should be secured.

The receiver according to the embodiments of the present invention has a digital intensive structure. Also, the receiver can be suitably used for multiband and multi-application.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A receiver, comprising:
an RF/analog block comprising a noise reduction and signal magnitude mapping variable gain amplification unit and an analog-to-digital conversion unit, wherein the noise reduction and signal magnitude mapping variable gain amplification unit comprises filters and an amplifier and is configured to amplify and band-pass an analog signal, reduce a white noise and an interfering signal except for a band signal, and convert a relatively wide signal amplitude range of an input signal into an input signal amplitude range of a next stage, and the analog-to-digital conversion unit is configured to convert the analog signal passed through the noise reduction and signal magnitude mapping variable amplification unit into a digital signal of a DC-frequency band or intermediate-frequency band by performing a sampling operation using a sampling clock of a preset frequency for a carrier frequency of a desired signal to be sub-sampled and for a band of the desired signal to be over-sampled, have a range of input signal magnitude capable of processing all of the desired signal and its neighboring unwanted signal, and generate the digital signal for each I/Q path being provided with a high-speed input unit for sampling a signal of higher frequency than the sampling clock frequency; and
a digital signal restoration block comprising a digital low-pass filter, a digital variable gain amplifier, an auto gain control unit, a clock frequency generator, and a digital processor, wherein the digital low-pass filter is configured to select a signal of a desired channel among output signals of the analog-to-digital conversion unit, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

2. The receiver of claim 1, wherein the clock frequency generator has programmability to an output frequency for selecting a desired-channel signal and keeps a center frequency of an output band of the analog-to-digital conversion unit constant by varying a sampling frequency supplied to the analog-to-digital conversion unit.

3. The receiver of claim 1, wherein the digital low-pass filter has a structure capable of varying a bandwidth for selecting a desired-channel signal.

4. The receiver of claim 1, wherein the digital low-pass filter has a form of an I/Q path filter or an I/Q complex filter.

5. The receiver of claim 1, wherein the digital low-pass filter, the digital variable gain amplifier, and the auto gain control unit are arbitrarily arranged.

6. A receiver, comprising:
an RF/analog block comprising a noise reduction and signal magnitude mapping variable gain amplification unit and an analog-to-digital conversion unit, wherein the noise reduction and signal magnitude mapping variable amplification unit comprises filters and an amplifier and is configured to amplify and band-pass an analog signal, reduce a white noise and an interfering signal except for a band signal, and convert a relatively wide signal amplitude range of an input signal into an input signal amplitude range of a next stage, and the analog-to-digital conversion unit is configured to convert the analog signal passed through the noise reduction and signal magnitude mapping variable gain amplification unit into a digital signal of a DC-frequency band or intermediate-frequency band by performing a sampling operation using a sampling clock of a preset frequency for a carrier frequency of a desired signal to be sub-sampled and for a band of the desired signal to be over-sampled, have a range of input signal magnitude capable of processing all of the desired signal and its neighboring unwanted signal, and generate the digital signal for each I/Q path being provided with a high-speed input unit for sampling a signal of higher frequency than the sampling clock frequency; and
a digital signal restoration block comprising a digital down mixer, a digital low-pass filter, a digital variable gain amplifier, an auto gain control unit, a clock frequency generator, and a digital processor, wherein the digital down mixer is configured to receive an output signal of the analog-to-digital conversion unit and down-convert its center frequency into a DC band, the digital low-pass filter is configured to select a signal of a desired channel among output digital signals of the digital down mixer, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

7. The receiver of claim 6, wherein the clock frequency generator has programmability to an output frequency for selecting a desired-channel signal, keeps a center frequency of an output band of the digital down mixer constant by varying a frequency of a mixing signal supplied to the digital down mixer, and varies a sampling clock frequency supplied to the analog-digital conversion unit.

8. The receiver of claim 6, wherein the digital low-pass filter has a structure capable of varying a bandwidth for selecting a desired-channel signal.

9. The receiver of claim 6, wherein the digital low-pass filter has a form of an I/Q path filter or an I/Q complex filter.

10. The receiver of claim 6, wherein the digital down mixer has a form of an I/Q path mixer or an I/Q complex mixer.

11. The receiver of claim 6, wherein the digital down mixer, the digital low-pass filter, the digital variable gain amplifier, and the auto gain control unit are arbitrarily arranged.

12. The receiver of claim 1 or 6, wherein the analog-to-digital conversion unit in the RF/analog block is structured with I/Q ADCs and the ADCs directly receive orthogonal I/Q clocks respectively.

13. A receiver, comprising:
an RF/analog block comprising a noise reduction and signal magnitude mapping variable gain amplification unit and an analog-to-digital conversion unit, wherein the noise reduction and signal magnitude mapping variable gain amplification unit comprises filters and an amplifier and is configured to amplify and band-pass an analog signal, reduce a white noise and an interfering signal except for a band signal, and convert a relatively wide signal amplitude range of an input signal into an input signal amplitude range of a next stage, and the analog-to-digital conversion unit is configured to convert the analog signal passed through the noise reduction and signal magnitude mapping variable gain amplification unit into a digital signal of a DC-frequency band or intermediate-frequency band by performing a sampling operation using a sampling clock of a preset frequency for a carrier frequency of a desired signal to be sub-sampled and for a bandwidth of the desired signal to be over-sampled, have a range of input signal magnitude capable of processing all of the desired signal and its neighboring unwanted signal, and generate the digital signal as a single path being provided with a high-speed input unit for sampling a signal of higher frequency than the sampling clock frequency; and
a digital signal restoration block comprising a quadrature digital down mixer, a digital low-pass filter, a digital variable gain amplifier, an auto gain control unit, a clock frequency generator, and a digital processor, wherein the quadrature digital down mixer is configured to receive an output signal of the analog-to-digital conversion unit and down-convert its center frequency into a DC band, the digital low-pass filter is configured to select a signal of a desired channel among output digital signals of the digital down mixer, the digital variable gain amplifier is configured to make a digital-filtered signal have a referential arbitrary signal magnitude, the auto gain control unit is configured to detect a magnitude of a signal to automatically vary a gain of the digital variable gain amplifier according to the signal magnitude, the clock frequency generator is configured to generate the sampling clock of the analog-to-digital conversion unit, and the digital processor is configured to process a signal passed through the digital variable gain amplifier.

14. The receiver of claim 13, wherein the clock frequency generator has programmability to an output frequency for selecting a desired-channel signal, keeps a center frequency of an output band of the quadrature digital down mixer constant by varying a frequency of a mixing signal supplied to the quadrature digital down mixer, and varies a sampling clock frequency supplied to the analog-digital conversion unit.

15. The receiver of claim 13, wherein the digital low-pass filter has a structure capable of varying a bandwidth for selecting a desired-channel signal.

16. The receiver of claim 13, wherein the digital low-pass filter has a form of an I/Q path filter or an I/Q complex filter.

17. The receiver of claim 13, wherein the quadrature digital down mixer has a form of an I/Q path mixer or an I/Q complex mixer.

18. The receiver of claim 13, wherein the quadreature digital down mixer, the digital low-pass filter, the digital variable gain amplifier, and the auto gain control unit are arbitrarily arranged.

19. The receiver of claim 1, 5, or 10, wherein the filter between the amplifier and the analog-to-digital conversion unit has a function of impedance conversion for changing a voltage level of a signal power transferred to an ADC and a function of frequency selective noise cancelling using a frequency selective 180°-phase converter and a common mode suppression circuit.
